(19) United States
(12) Patent Application Publication
(10) Pub. No.: US 2005/0076871 A1
(43) Pub. Date: Apr. 14, 2005

(54) Air intake system for automobiles

(76) Inventor: Nam Kyun Paek, Gunpo-city (KR)

Correspondence Address: MORGAN, LEWIS & BOCKIUS LLP (SF), 2 PALO ALTO SQUARE, PALO ALTO, CA, 94306, US

(21) Appl. No.: 10/962,029

(22) Filed: Oct. 8, 2004

(30) Foreign Application Priority Data
Oct. 14, 2003 (KR) 10-2003-0071515

(51) Int. Cl. F02M 35/16

(52) U.S. Cl. 123/184.21; 180/68.3

(57) ABSTRACT

An air intake system for an automobile minimizes the induction of foreign particulates into the engine intake. Air flowing into the engine intake opening is caused to flow in substantially an “S” pattern, thereby, minimizing particulates, such as snow and water, from entering the engine intake with engine intake air.

### CROSS-REFERENCE TO RELATED APPLICATIONS

This application claims priority of Korean Application No. 10-2003-0071515, filed Oct. 14, 2003, the disclosure of which is incorporated herein by reference.

### TECHNICAL FIELD OF THE INVENTION

The present invention relates to an air intake system for an automobile. More specifically, the air intake system can minimize foreign particulates, such as snow and water from entering the engine through the intake opening.

### BACKGROUND OF THE INVENTION

Generally, the air intake system in automobiles comprises an engine intake opening coupled with an air cleaner through an intake duct. The air duct connects the air cleaner with a surge tank of the intake manifold. The throttle body is mounted on the surge tank and the intake manifold is equipped with a discharge port that is divided so that the air from outside can be distributed to each cylinder.

Air taken in through the engine intake opening and intake duct is cleaned by the air cleaner. The air is then supplied to the engine through the air duct, adjusted in supply amount through the throttle body, and supplied to each of the engine cylinders through the surge tank and the intake manifold. Generally, as the vehicle's speed increases, the revolution's per minute (rpm) of the engine increases, and the engine requires more air. Thus, the engine intake opening is traditionally placed toward the vehicle running direction to expedite air inflow and increase the air intake in proportion to the running speed of the vehicle.

However, a forward facing engine intake opening often provides an opening through which foreign objects, such as snow and water can enter and clog the engine intake opening. Furthermore, icing can occur at the throttle body due to the incoming cold snow making it difficult to start or run the vehicle.

### SUMMARY OF THE INVENTION

According to an embodiment of the present invention, an air intake system for an automobile can block foreign particulates so they are minimized from entering into the engine intake opening. The air intake is detoured from the running direction of the vehicle so that foreign particulates are not directly sucked into the engine intake opening.

An embodiment of the present invention includes an air intake system of an automobile with an engine intake opening placed such that intake air is detoured from an entry direction in line with the vehicle running direction. The intake induction system has an opening formed on one of the side portions and an internal chamber inducing the air to the engine intake opening. A reinforced partition is formed in the internal chamber of the intake induction system for increased stiffness. A plurality of ribs are formed on the external surface of the intake induction system in the vertical direction. A auxiliary opening is formed on the rear of the intake induction system. The auxiliary opening is formed by a space between the engine intake opening and the bottom of the intake induction system. The air flowing through the auxiliary opening and supplied to the engine intake opening forms an S shaped flow path. Also, a projection is formed to prevent foreign particulates from entering through the auxiliary opening at the bottom of the intake induction system into the engine intake opening.

### BRIEF DESCRIPTION OF THE DRAWINGS

For better understanding of the nature and objects of the invention, reference should be made to the following detailed description, taken in conjunction with the accompanying drawings, in which:

FIG. 1 is a perspective view of a structure of an engine intake induction system of an automobile according to an embodiment of the present invention;

FIG. 2 is a front view of the intake induction system illustrated in FIG. 1;

FIG. 3 is a left side view of the intake induction system illustrated in FIG. 1;

FIG. 4 is a right side view of the intake induction system illustrated in FIG. 1;

FIG. 5 is a bottom view of the intake induction system illustrated in FIG. 1;

FIG. 6 is a cross-sectional view taken along the line VI-VI in FIG. 1; and

FIG. 7 is a longitudinal-sectional view taken along the line VII-VII of FIG. 1.

### DETAILED DESCRIPTION OF PREFERRED EMBODIMENTS

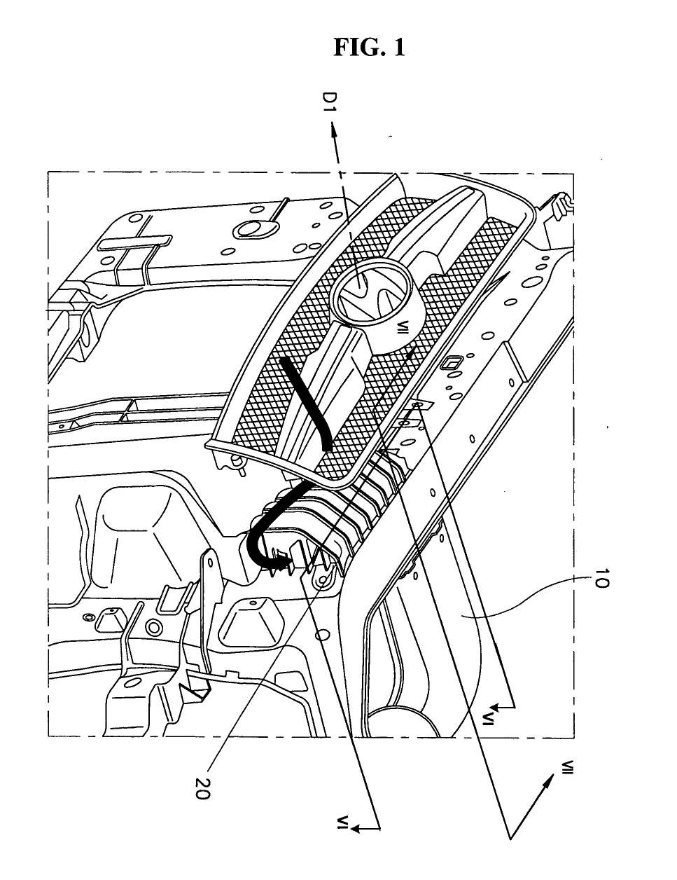

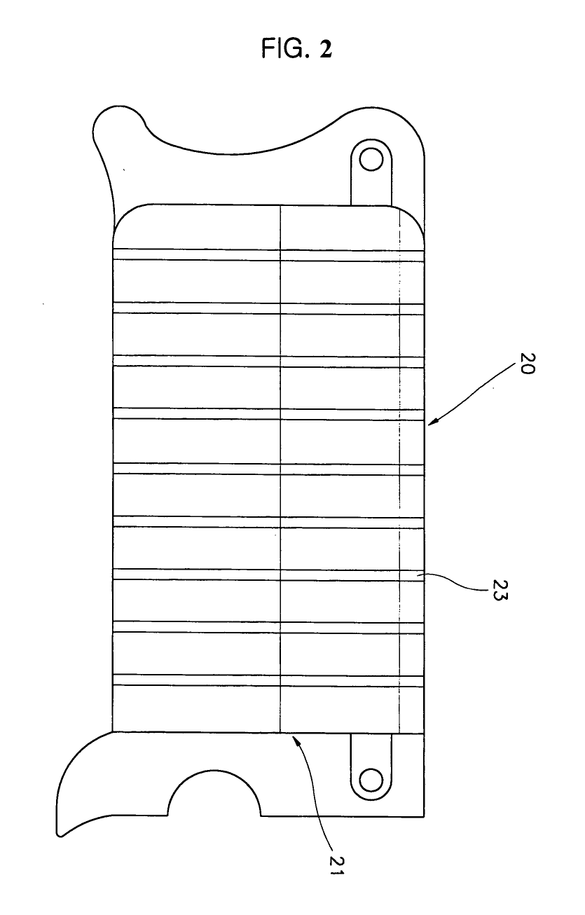

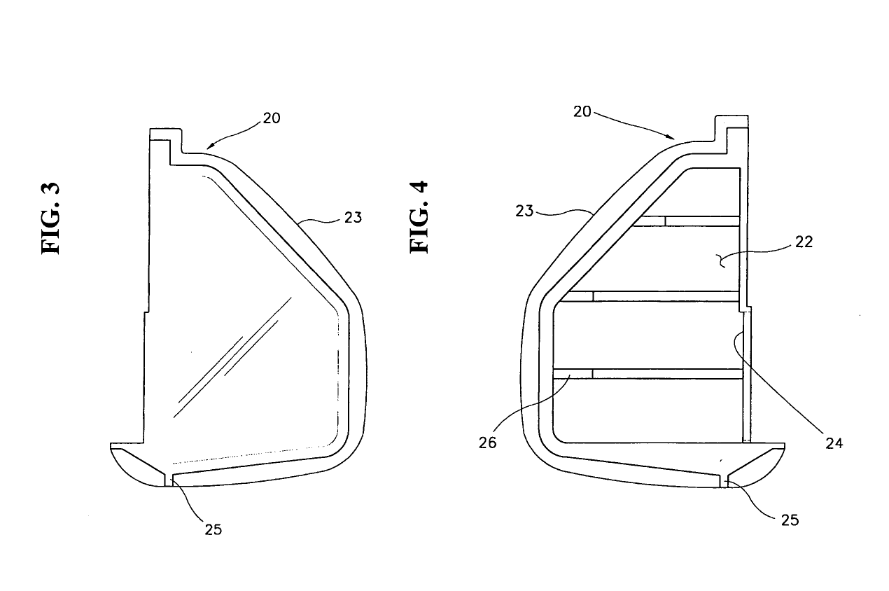

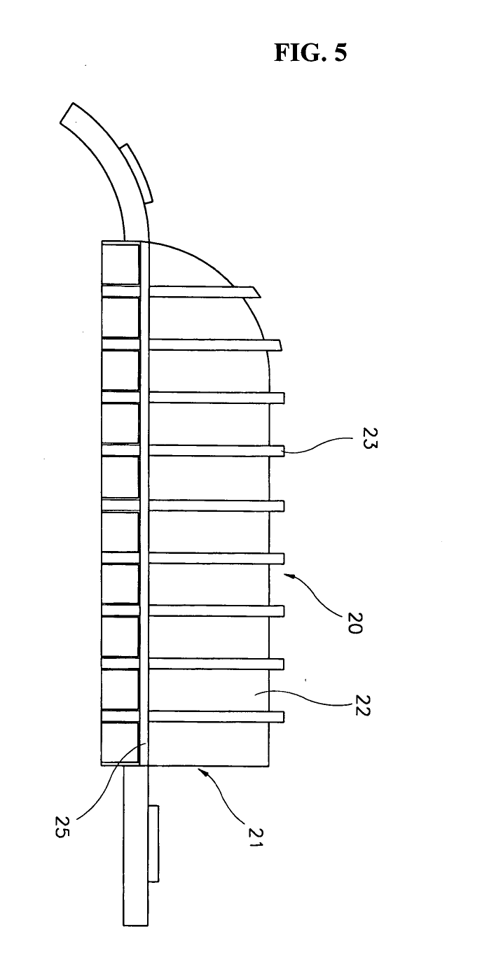

According to FIG. 1, the air intake system according to an embodiment of the present invention has an intake induction system 20 installed on an engine intake opening 10. This intake induction system 20 changes a direction of air flown into the engine from the vehicle running direction to other directions. As shown in FIGS. 2-5, the intake induction system 20 has an opening 21 formed on one side and has an interior chamber 22 that induces the air flowing from this opening 21 to the engine intake opening 10. Preferably, the intake induction system 20 has a plurality of ribs 23 formed on an external surface, facing the vehicle running direction D1, and extending in a vertical direction with respect to the vehicle.

According to a preferred embodiment, the intake induction system 20 has an auxiliary opening 24. The auxiliary opening 24 is formed on the rear bottom of the intake induction system 20 by the space created by making its bottom longer than the engine intake opening 10 in the underside. The intake induction system 20 has the partition 26 formed in the interior chamber 22 to strengthen its stiffness. The intake induction system 20 also has at least one projection 25 formed on the section adjacent to the auxiliary opening 24 at the bottom of the intake induction system 20 to prevent foreign particulates from flowing into the auxiliary opening 24.

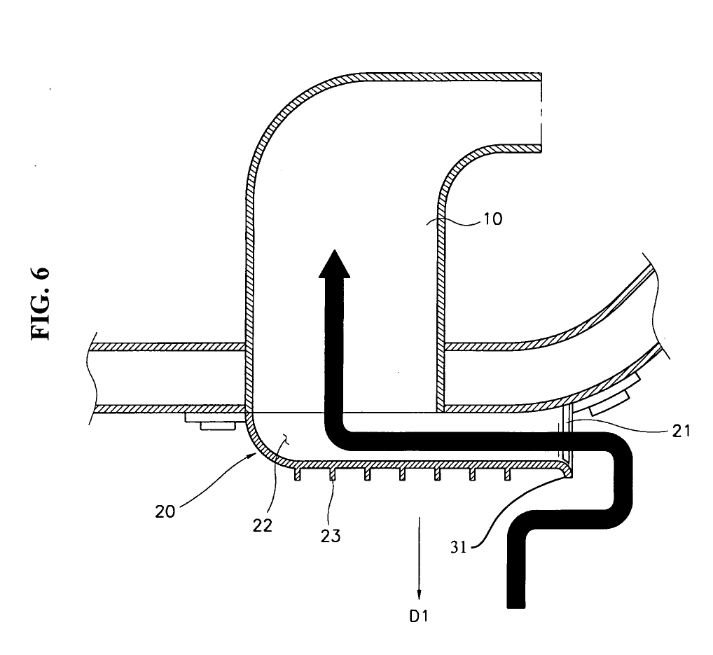

Referring to FIG. 6, it can be seen that air flowing into the engine intake induction system from the vehicle running direction D1 does not directly flow to the engine intake opening 10. The intake air flow is changed in direction to the right side by the intake induction system 20. The air flows in through the opening 21 of the intake induction system 20 and is then sucked into the engine intake opening 10 as it travels through the interior chamber 22. Therefore, even though snow or water travels toward the engine intake from the vehicle running direction D1, foreign particulates are blocked by the intake induction system 20 and thus not sucked into the engine intake opening 10.

A plurality of ribs 23 are formed on the front side of the intake induction system 20. The plurality of ribs 23 intercept foreign particles, such as snow and water that become absorbed or adhered on the surface of the intake induction system 20 and attempt to flow into the opening 21. Also, opening 21 is formed with a bell mouth created by outwardly curved lip 31. The bell mouth and lip 31 further minimize entry of foreign particles into opening 21 and facilitate air supply thereto.

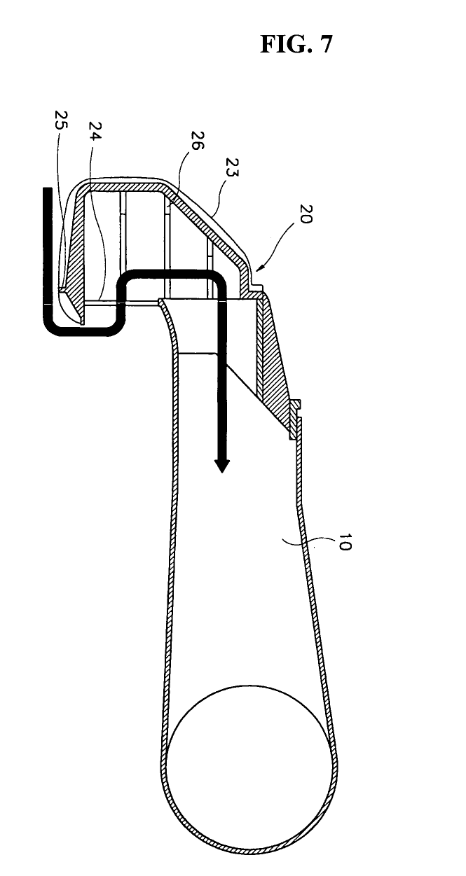

As shown in FIG. 7, some of the air flown in from the vehicle running direction D1 flows into the air intake system through the auxiliary opening 24 at the rear bottom of the intake induction system 20. This air enters into the engine intake opening 10 through the interior chamber 22 and supplements the air flown in by detour through the opening 21 on one side of the intake induction system 20. The air flown in from the auxiliary opening 24 is caused to change direction through the bottom of the intake induction system 20. Next, the air flows into the interior chamber 22 and then changes direction again when entering the engine intake opening 10. Therefore, the air entering through the auxiliary opening 24 is caused to enter the engine intake opening 10 moving in an “S” shape.

A projection 25 is positioned on the front side of the intake induction system 20. The projection 25 deflects foreign particles that may flow into the intake system through the auxiliary opening 24. For example, snow and water may adhere or absorb to the surface of the intake induction system 20 and be urged with the air flow from the moving vehicle to enter the auxiliary opening 24, however, the projection 25 minimizes these foreign particles from entering the system.

Preferably, the opening 21 and the auxiliary opening 24 are integrally formed with the intake induction system 20.

According to another embodiment, the present invention comprises the installation of the intake induction system for changing the direction of air flowing into the engine intake opening from the front to a side and thereafter guiding it to the engine intake opening, by which the air flown in from the vehicle running direction is diverted through a detour and not sucked directly into the engine intake opening. Therefore, such foreign particulates as snow, water, and the like can be blocked from entering the engine intake opening and thus prevent trouble that can happen to an engine from the entry of unwanted foreign particulates into the engine.

It will be appreciated by one of ordinary skill in the art that the invention is not restricted to the exemplary embodiments described above, but is intended to cover the many various modifications and adjustments that may be included in the scope of the present invention as defined by the appended claims.

1. An air intake system in automobile, comprising:
an engine intake opening toward a vehicle running direction; and
an intake induction system disposed in front of said engine intake and configured and dimensioned to route incoming air through a circuitous path prior to entering said engine intake opening.

2. The air intake system according to claim 1, wherein said intake induction system has an opening formed on a side portion thereof and an internal chamber inducing air flow in through the side opening to said engine intake opening.

3. The air intake according to claim 2, wherein a partition is formed in the interior chamber for increasing stiffness.

4. The air intake according to claim 2, wherein said side opening is formed with a bell mouth.

5. The air intake system according to claim 1, further comprising a plurality of ribs formed on an external surfaces of said intake induction system facing in the vehicle running direction.

6. The air intake system according to claim 5, wherein said ribs are formed in a vertical direction.

7. The air intake system according to claim 2, further comprising an auxiliary opening formed on a bottom rear of said intake induction system.

8. The air intake system according to claim 7, wherein the auxiliary opening is formed by a space between said engine intake opening and said bottom of said intake induction system.

9. The air intake system according to claim 8, wherein the air flowing through said auxiliary opening and supplied to the engine intake opening forms a “S” shaped flow pattern.

10. The air intake system according to claim 7, further comprising a blocking threshold formed to prevent foreign particulates from entering through said auxiliary opening at the bottom of said intake induction system.

11. The air intake system according to claim 7, wherein the opening and auxiliary opening of said intake induction system are integrarally formed with said intake induction system.

12. The air intake system according to claim 1, wherein said intake induction system has an opening formed in the direction opposite from the vehicle running direction and is equipped with an internal chamber inducing the air flowing in through this opening to said engine intake opening.

13. An air intake system for an automobile, comprising:
an engine intake duct leading intake air to an engine intake opening; and
an intake induction system leading the intake air to the engine intake duct;
wherein said intake induction system defines a side opening and an internal chamber through which the intake air flows to reach said engine intake duct such that intake air must flow through substantially an S pattern to reach the engine intake opening;
said intake induction system includes at least one partition configured and dimensioned within said internal chamber to increase a strength of said intake induction system; and
said intake induction system includes at least one vertical rib on a forward facing external surface of said intake induction system configured and dimensioned to reduce foreign particles from entering said side opening.

14. The air intake system of claim 13, further comprising:
an auxiliary intake opening defined in a rear bottom portion of said intake induction system; and
at least one projection adjacent to said auxiliary intake opening configured and dimensioned to prevent particulates from flowing into said auxiliary opening.

15. An air intake system for an automobile, comprising:
an engine intake duct leading intake air to an engine intake opening; and
an intake induction system leading the intake air to the engine intake duct;
wherein said intake induction system defines a side opening and an internal chamber through which the intake air flows to reach said engine intake duct such that said intake air flows through a circuitous path to reach the engine intake opening.

16. The air intake system of claim 15, further comprising at east one rib formed on an external surface of said intake induction system wherein said rib is configured and dimensioned to restrict snow and water from entering said side opening.

17. The air intake system of claim 15, wherein said intake induction system further defines an auxiliary opening on a bottom portion thereof and wherein a projection extends from said intake induction system to restrict snow and water from entering said auxiliary opening.

18. The air intake system of claim 15, wherein said circuitous path comprises a substantially S-shaped pattern.

19. The air intake system of claim 15, wherein said side opening is formed with a bell mouth.
